(19) United States
(12) Patent Application Publication
(10) Pub. No.: US 2003/0020027 A1
(43) Pub. Date: Jan. 30, 2003

(54) Apparatus for infrared reduction in ultraviolet radiation generators

(75) Inventor: Nigel Julian Keith Danvers, London (GB)

Correspondence Address: Kevin G. Rooney, Wood, Herron & Evans, L.L.P., 2700 Carew Tower, 441 Vine Street, Cincinnati, OH, 45202-2917, US

(73) Assignee: Nordson Corporation, Westlake, OH

(21) Appl. No.: 09/915,129

(22) Filed: Jul. 25, 2001

(51) Int. Cl. G01J 1/00

(52) U.S. Cl. 250/504 R

(57) ABSTRACT

An ultraviolet radiation generating system for treating an ultraviolet-reactive substance on a substrate. The system comprises a chamber having a wall, a plasma lamp mounted within the chamber in a confronting relationship with an interior surface of the wall, and a reflector positioned between the plasma lamp and the wall. When excited by energy from an excitation power source, the plasma lamp is capable of emitting radiation of infrared and ultraviolet wavelengths. The reflector is capable of reflecting ultraviolet radiation from the plasma lamp toward the substrate and transmitting infrared radiation such that the infrared radiation irradiates the interior surface of the wall. The interior surface is at least partially covered with an infrared-absorptive coating capable of absorbing infrared radiation incident thereon so that reflection therefrom is significantly reduced or eliminated. The reflector may be capable of absorbing infrared radiation that is reflected from the interior surface of the wall with optical paths directed toward a rear surface of the reflector.

### FIELD OF THE INVENTION

The present invention relates generally to ultraviolet radiation generators and, more particularly, to an apparatus for reducing infrared radiation in the radiation emitted by an ultraviolet radiation generator.

### BACKGROUND OF THE INVENTION

Controlled exposure to ultraviolet radiation can alter a physical, chemical or mechanical property of an ultraviolet-reactive substance, such as adhesives, sealants, inks, coatings, and the like. Typically, a substrate carrying the ultraviolet-reactive substance is radiated by ultraviolet radiation provided by an ultraviolet radiation generator. The ultraviolet radiation generator generally includes a chamber, a plasma lamp mounted within the chamber, and an excitation source which provides energy for initiating and sustaining a plasma from a gas mixture filling the plasma lamp. The gas mixture is elementally tailored such that the plasma produces a spectrum of electromagnetic radiation strongly weighted with one or more spectral lines of ultraviolet wavelength.

Some ultraviolet radiation emitted by the plasma lamp follows a direct optical path from the lamp to the substrate. However, a large portion of the ultraviolet radiation emitted by the plasma lamp has an indirect optical path to the substrate by single or multiple reflections. Conventional ultraviolet radiation generators often include a reflector mounted adjacent to the plasma lamp for increasing the flux of ultraviolet radiation exiting the generator with optical paths that intersect the location of the substrate. The reflector redirects ultraviolet radiation emitted by the plasma lamp in a predetermined focused or flood pattern toward the substrate.

The plasma lamp also produces and emits a significant flux of infrared radiation in addition to the flux of ultraviolet radiation. Some of the infrared radiation travels along the direct optical path from the plasma lamp to the substrate. The reflector often includes a reflection filter, such as a dichroic coating, that significantly reduces the reflection of infrared radiation by selectively transmitting infrared radiation and preferentially reflecting ultraviolet radiation emitted by the plasma lamp. Although the reflection filter removes infrared radiation from the ultraviolet radiation redirected by the reflector toward the substrate, the portion of the infrared radiation that is transmitted through the reflector irradiates the interior surface of one or more walls forming the chamber. The infrared radiation can either be absorbed, re-emitted or reflected by the walls. Infrared radiation that reflects from, or that is re-emitted by the walls, can reach the substrate indirectly if the corresponding optical paths pass the backside of the reflector in line-of-sight paths directed toward substrate.

Because infrared radiation can undesirably heat the substrate, the ability of reflected infrared radiation to reach the substrate is a significant concern in conventional ultraviolet radiation generators. Infrared radiation that irradiates a surface of the substrate produces a temperature increase. One solution for limiting the infrared radiation irradiating the substrate is to reduce or limit the output of the plasma lamp, which has the undesirable effect of also restricting the output of ultraviolet radiation and, accordingly, the effectiveness of the conventional ultraviolet radiation generator for treating the substrate.

Thus, an ultraviolet radiation generator is needed that can reduce the amount of infrared radiation reflected or re-emitted by the interior walls of the chamber toward the substrate.

### SUMMARY OF THE INVENTION

The present invention overcomes the foregoing and other deficiencies of conventional ultraviolet radiation generators. While the invention will be described in connection with certain embodiments, the invention is not limited to these embodiments. On the contrary, the invention includes all alternatives, modifications and equivalents as may be included within the spirit and scope of the present invention.

According to the present invention, an ultraviolet radiation generating system for treating an ultraviolet-reactive substance on a substrate comprises a chamber, a plasma lamp mounted within the chamber, and an excitation power coupled to the plasma lamp. The plasma lamp contains a gas mixture capable of emitting infrared and ultraviolet radiation when the gas mixture is excited by the excitation power source to generate a plasma. The plasma lamp has a confronting relationship with an interior surface of a wall of the chamber. At least a portion of the interior surface of the wall is covered by an infrared-absorptive coating capable of absorbing a significant portion of the infrared radiation incident thereon for significantly reducing the amount of infrared radiation reflected from the interior surface.

In another embodiment of the present invention, a ultraviolet radiation generating system for treating an ultraviolet-reactive substance on a substrate comprises a chamber, a plasma lamp mounted within the chamber, a reflector positioned between the plasma lamp and the wall, and an excitation power coupled to the plasma lamp. The plasma lamp contains a gas mixture capable of emitting infrared and ultraviolet radiation when the gas mixture is excited by the excitation power source to generate a plasma.

The plasma lamp has a confronting relationship with an interior surface of the reflector. The reflector is capable of reflecting ultraviolet radiation emitted by the plasma lamp toward the substrate and transmitting infrared radiation emitted by the plasma lamp so that the transmitted infrared radiation irradiates the interior surface of the wall. The reflector is capable of absorbing a significant portion of the transmitted infrared radiation reflected by the interior surface of the wall with optical paths directed toward a rear surface of the reflector. For example, the rear surface of the reflector may comprise a surface treatment capable of absorbing the reflected infrared radiation.

In another embodiment of the present invention, a ultraviolet radiation generating system for treating an ultraviolet-reactive substance on a substrate comprises a chamber, a plasma lamp mounted within the chamber, a reflector positioned between the plasma lamp and the wall, and an excitation power coupled to the plasma lamp. The plasma lamp contains a gas mixture capable of emitting infrared and ultraviolet radiation when the gas mixture is excited by the excitation power source to generate a plasma. The plasma lamp has a confronting relationship with an interior surface of the reflector. The reflector is capable of reflecting ultraviolet radiation emitted by the plasma lamp toward the substrate and transmitting infrared radiation emitted by the plasma lamp so that the transmitted infrared radiation irradiates the interior surface of the wall. The reflector is capable of absorbing a significant portion of the transmitted infrared radiation reflected from the interior surface of the wall with optical paths directed toward a rear surface of the reflector. At least a portion of the interior surface of the wall is covered with an infrared-absorptive coating capable of absorbing a significant portion of the transmitted infrared radiation incident thereon for significantly reducing the amount of infrared radiation reflected from the interior surface.

The present invention significantly reduces the amount of infrared radiation emitted by the radiation generator that can strike the substrate. As a result, the plasma lamp can be operated at greater power levels without heating the substrate beyond tolerances characteristic of the treatment process and the particular ultraviolet-reactive coating. Because the plasma lamp can be operated at a greater power level, the available irradiance of ultraviolet radiation output by plasma lamp can be significantly increased for use in treating the ultraviolet-reactive coating on the surface of the substrate. As a result, the treatment rate for the ultraviolet-reactive coating can be significantly accelerated by operating the plasma lamp at a higher power level and, accordingly, the throughput of the process line utilizing the ultraviolet treatment generator can be significantly increased. The above and other advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a side perspective view of an ultraviolet radiation generator having a chamber according to the present invention;

FIG. 2 is a partial transverse cross-sectional view of an ultraviolet radiation generator taken along line 2-2 of FIG. 1;

FIG. 3 is an enlarged view of encircled area 3 of FIG. 2, which according to the present invention has interior surfaces covered by an infrared-absorbing coating; and

FIG. 4 is an enlarged view of encircled area 4 of FIG. 2, but showing an alternative reflector construction for absorbing infrared radiation.

### DETAILED DESCRIPTION OF THE PREFERRED EMBODIMENTS

The present invention relates to ultraviolet radiation generators configured to uniformly irradiate a substrate carrying an ultraviolet-reactive substance with ultraviolet radiation while significantly reducing the amount of infrared radiation that is reflected toward the substrate.

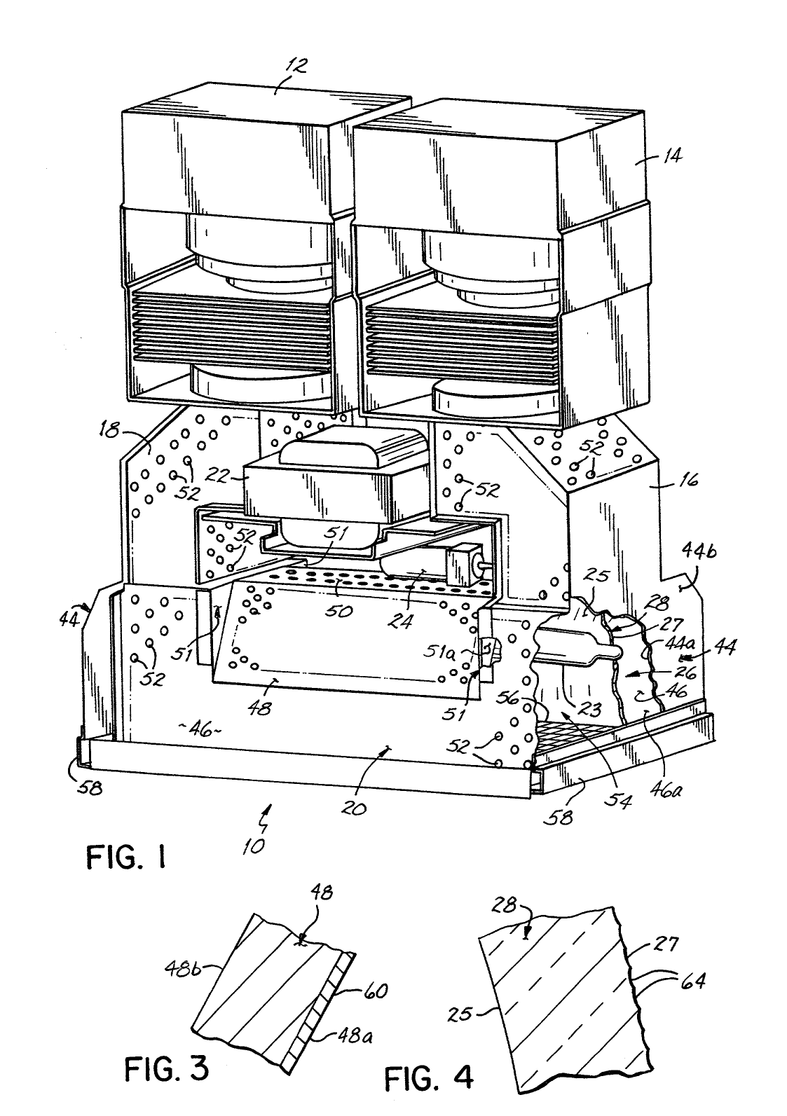

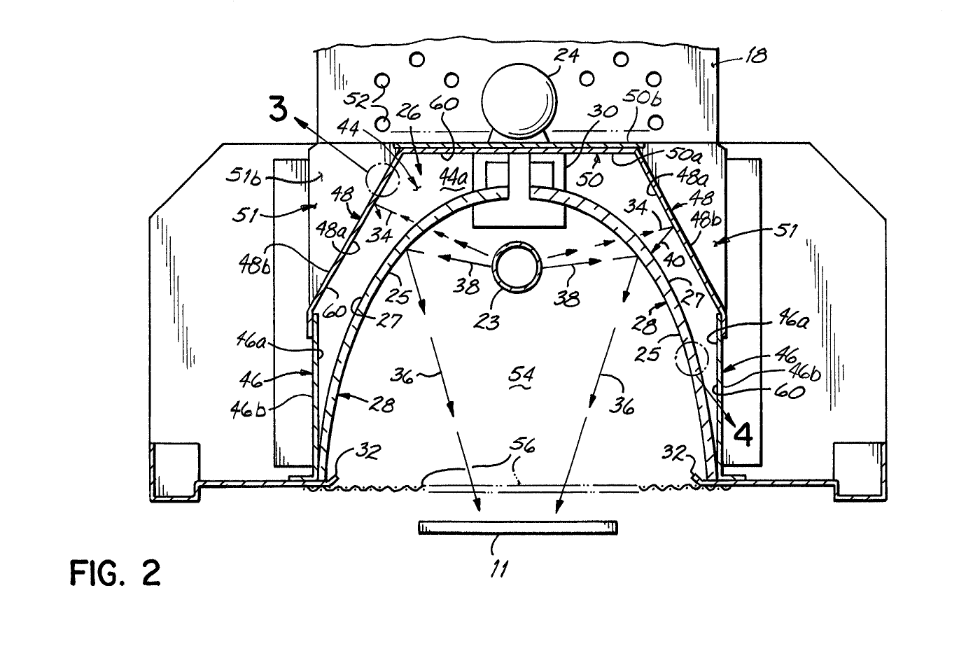

With reference to FIGS. 1 and 2, an ultraviolet radiation generator in accordance with the present invention is indicated generally by reference numeral 10. Radiation generator 10 is used for the treatment of a substrate 11 which is at least partially covered by an ultraviolet-reactive substance, such as an ultraviolet-curable substance. As used herein, treatment is defined as curing, heating, or any other process that alters a physical, chemical or mechanical property of the ultraviolet-reactive substance as a result of exposure to ultraviolet radiation. Radiation generator 10 includes a pair of microwave generators 12 and 14, illustrated as magnetrons, operably connected by a respective one of a pair longitudinally-spaced waveguides 16 and 18 to a longitudinally-extending microwave chamber, indicated generally by reference numeral 20. A pair of transformers 22 (the second transformer not shown) are electrically coupled to a respective one of the microwave generators 12 and 14 for energizing the microwave generators 12 and 14 as understood by those of ordinary skill in the art.

A plasma lamp 23 extends longitudinally within the microwave chamber 20 and is mounted within the microwave chamber 20 as understood by those of ordinary skill in the art. Plasma lamp 23 comprises a sealed, longitudinally-extending tube formed of an ultraviolet-transmissive material, such as vitreous silica, and filled with a gas mixture. For ultraviolet treating applications, a particularly useful gas mixture comprises a mercury vapor and an inert gas, such as argon. The gas mixture may further include trace amounts of an element such as iron, gallium, or indium for tailoring the spectral output. A small quantity of mercury is vaporized to provide the mercury vapor.

A starter bulb 24 is provided to assist the microwave generators 12 and 14 in initiating a plasma within plasma lamp 23. Once the plasma is initiated in plasma lamp 23, waveguides 16 and 18 direct microwave energy from the microwave generators 12 and 14 to the microwave chamber 20 where the energy couples to the plasma. Microwave energy is deposited with a three-dimensional density distribution within the microwave chamber 20 as understood by those of ordinary skill in the art. By adjusting the shape of microwave chamber 20, the three-dimensional distribution of the microwave energy may be selected to efficiently excite the gas mixture along the entire longitudinal dimension of the plasma lamp 23.

The plasma in plasma lamp 23 emits photons having a predetermined distribution of wavelengths that includes highly intense ultraviolet and infrared spectral components. As used herein, radiation is defined as photons having wavelengths ranging between about 200 nm to about 2500 nm, ultraviolet radiation is defined as photons having wavelengths ranging between about 200 nm to about 400 nm, and infrared radiation is defined as photons having wavelengths ranging between about 700 nm to about 2500 nm.

Although radiation generator 10 is illustrated as a microwave-excited radiation generator, those of ordinary skill in the art appreciate that the present invention is not so limited. For example, the microwave generators 12 and 14 and waveguides 16 and 18 may be replaced with a source of radiofrequency (RF) energy operably coupled with the plasma lamp 23 for initiating and sustaining a plasma from the gas mixture therein. As another example, the plasma lamp 23 may be reconfigured with electrodes on opposed ends for operable connection to a source of electrical power capable of exciting a plasma discharge from the gas mixture in the lamp 23.

A longitudinally-extending reflector, indicated generally by reference numeral 26, is positioned within the microwave chamber 20. As best shown in FIG. 2, reflector 26 includes a pair of reflector panels 28 having a spaced relationship relative to the plasma lamp 23 and relative to each other. The reflector 26 is mounted on longitudinally spaced-apart retainers 30 within the microwave chamber 20 and is supported on opposed generally horizontal, inwardly-directed flanges 32. Each reflector panel 28 has a front surface 25 facing the plasma lamp 23 and an opposite rear surface 27. The reflector panels 28 readily transmit microwave energy provided by microwave generators 12 and 14 to couple with the plasma in plasma lamp 23. Reflector panels 28 are typically formed of a radiation-transmissive material having suitable reflective and thermal properties, such as a borosilicate glass or, more specifically, a Pyrex® glass. Although the panels 28 of reflector 26 are illustrated as having a front surface 25 that is concave and a rear surface 27 that is convex, such as having a curvature that is either parabolically-shaped or elliptically-shaped, the present invention is not so limited and the reflector 26 may comprise, for example, multiple planar panels arranged in a rectangular array or may comprise a single panel or multiple panels of other or similar shapes and having other geometrical arrangements.

With reference to FIG. 2, reflector 26 is capable of transmitting at least photons of infrared radiation, indicated diagrammatically by arrows 34, and reflecting at least photons of ultraviolet radiation, indicated diagrammatically by arrows 36, from the spectrum of emitted radiation, indicated diagrammatically by arrows 38, emanating from the plasma lamp 23. The transmission of infrared radiation 34 and reflection of ultraviolet radiation 36 can be increased by, for example, applying a dichroic coating to the front surface 25 of reflector 26. It is understood that radiation generator 10 may be configured without a reflector 26 and remain operable for irradiating substrate 11 with a flux of ultraviolet radiation emitted by plasma lamp 23.

As best understood with reference to FIGS. 1 and 2, the microwave chamber 20 surrounds the plasma lamp 23 and includes a pair of generally vertical opposite end walls 44 and a pair of generally vertical side walls 46 extending longitudinally between the end walls 44 and on opposite sides of the plasma lamp 23. A pair of inclined walls 48 interconnect a respective one of the side walls 46 with a horizontal upper wall 50 positioned between two pairs of generally vertical inner walls 51. Walls 44-51 have interior surfaces 44a-51a, respectively, facing and surrounding the plasma lamp 23 with a confronting relationship and exterior surfaces 44b-51b. The interior walls 44a-51a partially absorb and partially reflect the photons of infrared radiation 34. Infrared radiation 34 absorbed by walls 44-51 will be converted to heat and dissipated thermally as a function of the mass and heat capacity of the walls 44-51. A plurality of apertures 52 is provided in walls 44-51 to permit a flow of a cooling gas to be passed through the radiation generator 10. Although not shown, it is appreciated that radiation generator 10 is installed in a cabinet that provides pressurized gas cooling and electrical utilities necessary to operate the radiation generator 10.

Microwave chamber 20 is formed of a metal, such as a stainless steel, that confines the microwave energy to the interior space 54 of the microwave chamber 20 and that has a high thermal conductivity. Walls 44-51, and in particular, the interior surfaces 44a-51, define an interior space 54 that substantially surrounds the plasma lamp 23. It is understood that the walls 44-51 can be reshaped or repositioned to alter the density distribution of microwave energy within the interior space 54 of microwave chamber 20 without departing from the spirit and scope of the present invention.

Radiation escapes the interior space 54 of microwave chamber 20 through an opening provided in the base of chamber 20. The opening is covered by a mesh screen 56 mounted to a pair of generally horizontal flanges 58 that extend inwardly from the chamber side walls 46. The mesh screen 56 is substantially transparent to ultraviolet radiation 36 and infrared radiation 34 while simultaneously confining microwaves generated by microwave generators 12 and 14 to the interior space 54. Mesh screen 56 is formed of a metal having high electrical conductivity, such as tungsten, and a high transmission efficiency for ultraviolet radiation 36 and infrared radiation 34, typically greater than about 90%.

Ultraviolet radiation 36 and infrared radiation 34 may follow a direct optical path, without reflection, from plasma lamp 23 through the mesh screen 56 to the substrate 11. Ultraviolet radiation 36 and infrared radiation 34 may be reflected by reflector 26 with optical paths directed toward mesh screen 56. Infrared radiation 34, in particular, transmitted through the reflector panels 28 is incident upon the surfaces 44a-51a of the walls 44-51 and is capable of being reflected thereby as reflected infrared radiation, indicated diagrammatically by arrow 40, with angles of reflection such that the optical paths are directed through the rear surface 27 of reflector panels 28 toward mesh screen 56 and possibly toward substrate 11.

In accordance with one embodiment of the present invention, the surfaces 44a-51a of the walls 44-51, respectively, are covered with an infrared-absorptive coating 60, as best shown in FIG. 3. However, the infrared-absorptive coating 60 may be applied to only a portion of any or all of surfaces 44a-51a and may be applied uniformly or, alternatively, as a patterned layer without departing from the spirit and scope of the present invention. The infrared-absorptive coating 60 is capable of absorbing at least a portion of the infrared radiation 34 emitted by plasma lamp 23 that passes through the panels 28 of reflector 26 and is incident upon surfaces 44a-51a. Preferably, the absorption of the infrared radiation 34 by the infrared-absorptive coating 60 significantly exceeds the total sum of the contributions due to scattering, reflection, re-emission or transmission of the infrared radiation 34 by surfaces 44a-51a. Most preferably, the infrared-absorptive coating 60 absorbs substantially all of the infrared radiation 34 emitted by plasma lamp 23 that is incident upon surfaces 44a-51a.

According to the present invention, the infrared-absorptive coating 60 incorporates a thermally-stable coloring pigment which exhibits a significant infrared absorptance or infrared absorption factor in the wavelength range of the infrared radiation 34 generated by plasma lamp 23.

In particular, the infrared absorption factor of the infrared-absorptive coating 60 is substantially greater than the infrared absorption factor of the uncoated or bare metal forming walls 44-51. The energy from the infrared radiation 34 absorbed by the infrared-absorptive coating 60 is transformed to heat, which is conducted throughout the walls 44-51 and increases the temperature of the metallic mass forming walls 44-51. The flow of cooling gas about the walls 44-51 and through the plurality of apertures 52 aids in dissipating the heat and regulating the temperature of radiation generator 10.

Generally, coloring pigments suitable for use in the present invention comprise natural or synthetic substances in suspension that impart color to another substance. Infrared-absorptive coating 60 is most effective if black in color and, to that end, coloring pigments suitable for the present invention include, but are not limited to, temperature-resistant black pigments based on materials such as Fe₃O₄, carbon black, black iron oxides, the Fe₂O₃/Mn₂O₃ family, and the like. However, it is contemplated that infrared-absorptive coating 60 may have a different color, tone or hue provided by non-black coloring pigments without departing from the spirit and scope of the present invention. In certain embodiments of the present invention, the infrared-absorptive coating 60 with a black coloring pigment has been found to reduce the irradiance of infrared radiation 34 at the substrate 11 by about 7%.

The ability of the infrared-absorptive coating 60 to absorb the infrared radiation 34 depends, among other relevant parameters, upon the size, aspect ratio, and geometry of the pigment particles, the thickness of coating 60, and the separation distance between adjacent pigment particles in coating 60. Typically, the pigment particles comprising the coloring pigment have a particle size distribution ranging from about 0.5 μm to about 25 μm in diameter. However, the present invention is not so limited and the pigment particles may be provided in smaller or larger uniform sizes or size distributions. The pigment particles should be thermally stable over the operating temperature range of the walls 44-51 when the radiation generator 10 is operating.

The infrared-absorptive coating 60 may be applied to at least a portion of surfaces 44a-51a as a liquid or paint consisting of the coloring pigment particles, usually about 1 wt. % to about 6 wt. %, suspended in a suitable vehicle in a proportion sufficient to permit application to a surface by a conventional application technique. The infrared-absorptive coating 60 may be applied using known application techniques, for example, electrostatic painting machine or spray painting. Alternatively, the infrared-absorptive coating 60 may be applied to surfaces 44a-51a by a contact method utilizing a direct-application implement such as a paint brush or a paint roller. The infrared-absorptive coating 60 should not delaminate from the surfaces 44a-51a when the walls 44-51 are heated by operation of the radiation generator 10 to a typical operating temperature.

The vehicle for the coloring pigment in the liquid or paint, is usually selected to be a polymeric resin dissolved in an organic solvent, such as naphtha or xylene, or a water-based solvent, and is tailored to dry to a tough film as the solvent evaporates, leaving the polymer for binding the infrared-absorbing pigment particles to the surfaces 44a-51a. As the vehicle dries, the polymer typically cures by a chemical reaction with the moisture in the air. Silicone resins, in particular, are noted for their ability to withstand high temperatures and are suitable for use as a polymeric vehicle in the present invention.

In alternative embodiments, the coloring pigment may be prepared as a dry powder and the infrared-absorptive coating 60 applied as a powder coating by a method known in the art. Moreover, a black oxide layer, a black-pigmented PTFE coating, or a black anodized layer may serve as the infrared-absorptive coating 60 and be applied by suitable methods and techniques known to those of ordinary skill in the art. In other embodiments, the coloring pigment may be applied as a surface layer by conventional deposition methods such as Chemical Vapor Deposition (CVD) or Physical Vapor Deposition (PVD).

According to another embodiment of the present invention and with reference to FIGS. 1, 2 and 4, the rear surface 27 of reflector panel 28 peripherally distant from the plasma lamp 23 may be treated with a surface treatment 64 to create a non-optical surface or a filtering reflective coating. The surface treatment 64 on the rear surface 27 absorbs, scatters or otherwise reflects photons of infrared radiation or is infrared-absorptive such that reflected infrared radiation 40 reflected by surfaces 44a-51a is prevented from being transmitted back through the reflector panel 28 with optical paths that have a travel direction that could strike substrate 11 if not otherwise redirected. To that end, the rear surface 27 may be textured or roughened by, for example, shot peening. Alternatively, the surface treatment 64 may comprise a textured coating may be applied to the rear surface 27 that is operable for reducing the likelihood that photons of reflected infrared radiation 40 (FIG. 2) reflected by surfaces 44a-51a will be transmitted through the reflector panel 28. Other alternative surface treatments 64 for reducing the retransmission of reflected infrared radiation 40 are within the knowledge of those of ordinary skill in the art. Preferably, the surface treatment 64 enables reflector panel 28 to absorb substantially all of the reflected infrared radiation 40 reflected by the interior surfaces 44a-51a with optical paths directed toward the rear surface 27.

In an embodiment of the present invention, the surface treatment 64 is used in combination with the infrared-absorptive coating 60 for reducing or substantially eliminating the amount of infrared radiation 34 that exits the ultraviolet radiation generator 10 with an optical path that can strike substrate 11. Any reflected infrared radiation 40 from surfaces 44a-51a, despite the absorptive presence of infrared-absorptive coating 60, is further reduced by the surface treatment 64 on the rear surface 27 of the reflector 26. Despite the presence of surface treatment 64, reflector panel 28 retains the capability of transmitting a significant portion of the infrared radiation 34 not absorbed by the infrared-absorptive coating 60. As a result, the reflector panels 28 are not required to absorb an amount of reflected infrared radiation 40 that might otherwise significantly raise the temperature of the panels 28 but, instead, capture a significant portion of the reflected infrared radiation 40 not otherwise absorbed by the infrared-absorptive coating 60.

The embodiments of the present invention serve to reduce the infrared radiation 34 that strikes the substrate 11 so that the plasma lamp 23 can be operated at greater power levels without heating the substrate 11 beyond tolerances characteristic of the treatment process and the particular ultraviolet-reactive coating. Because the plasma lamp 23 can be operated at a greater power level, the available irradiance of ultraviolet radiation 36 output by plasma lamp 23 can be significantly increased for use in treating the ultraviolet-reactive coating on the surface of the substrate 11. As a result, the treatment rate for the ultraviolet-reactive coating can be significantly accelerated by operating the plasma lamp 23 at a higher power level and, accordingly, the throughput of the process line utilizing the ultraviolet treatment generator 10 can be significantly increased.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of applicants' general inventive concept

What is claimed is:

1. An ultraviolet radiation generating system for treating an ultraviolet-reactive substance on a substrate, said system comprising:
a chamber having a wall with an interior and exterior surface;
a plasma lamp mounted within said chamber and having a confronting relationship with said interior surface, said plasma lamp containing a gas mixture capable of emitting infrared and ultraviolet radiation when said gas mixture is excited to generate a plasma;
an excitation power source coupled to said plasma lamp for exciting the plasma from said gas mixture such that radiation having infrared and ultraviolet wavelengths is emitted by said plasma lamp; and
an infrared-absorptive coating covering at least a portion of said interior surface of said wall, said infrared-absorptive coating capable of absorbing said infrared radiation incident thereon for significantly reducing the amount of infrared radiation reflected from said interior surface.

2. The ultraviolet radiation generating system of claim 1, wherein said infrared-absorptive coating absorbs infrared radiation in an amount that reduces said infrared radiation irradiating the substrate by at least about 7%.

3. The ultraviolet radiation generating system of claim 1, wherein said infrared-absorptive coating absorbs substantially all of the infrared radiation incident thereon.

4. The ultraviolet radiation generating system of claim 1, wherein said infrared-absorptive coating is selected from the group consisting of a colored paint, a colored powder coating, a colored oxide layer, a color-pigmented PTFE layer, a colored anodized layer, a colored chemically-vapor-deposited film, a colored physically-vapor-deposited film, and combinations thereof.

5. The ultraviolet radiation generating system of claim 1, wherein said infrared-absorptive coating is selected from the group consisting of a black paint, a black powder coating, a black oxide layer, a black-pigmented PTFE layer, a black anodized layer, a black chemically-vapor-deposited film, a black physically-vapor-deposited film, and combinations thereof.

6. The ultraviolet radiation generating system of claim 1, wherein said infrared-absorptive coating comprises a plurality of coloring pigment particles that is capable of absorbing infrared radiation.

7. The ultraviolet radiation generating system of claim 6, wherein said infrared-absorptive coating further comprises a polymeric vehicle, said polyermic vehicle operable to adhere said coloring pigment particles to said interior surface of said wall.

8. An ultraviolet radiation generating system for treating an ultraviolet-reactive substance on a substrate, said system comprising:
a chamber having a wall with an interior and exterior surface;
a plasma lamp mounted within said chamber and having a confronting relationship with said interior surface, said plasma lamp containing a gas mixture capable of emitting infrared and ultraviolet radiation when said gas mixture is excited to generate a plasma;
an excitation power source coupled to said plasma lamp for exciting the plasma from said gas mixture such that radiation having infrared and ultraviolet wavelengths is emitted by said plasma lamp; and
a reflector positioned in said chamber between said plasma lamp and said wall, said reflector having a front surface facing said plasma lamp and a rear surface, said reflector capable of reflecting ultraviolet radiation emitted by said plasma lamp toward the substrate and transmitting infrared radiation emitted by said plasma lamp so that the transmitted infrared radiation irradiates said interior surface of said wall, and said reflector capable of absorbing a significant portion of the transmitted infrared radiation subsequently reflected from said interior surface of said wall with optical paths directed toward said rear surface of said reflector.

9. The ultraviolet radiation generating system of claim 8, wherein said rear surface further comprising a surface treatment capable of absorbing said portion of said infrared radiation.

10. The ultraviolet radiation generating system of claim 9, wherein said rear surface is roughened to absorb said portion of said infrared radiation.

11. The ultraviolet radiation generating system of claim 8, wherein said front surface is concave and said rear surface is convex, said rear surface further comprising a surface treatment capable of absorbing said portion of said infrared radiation.

12. The ultraviolet radiation generating system of claim 8, wherein said reflector is capable of absorbing substantially all of said infrared radiation reflected by said interior surface of said wall with optical paths directed toward said rear surface of said reflector.

13. An ultraviolet radiation generating system for treating an ultraviolet-reactive substance on a substrate, said system comprising:
a chamber having a wall with an interior and exterior surface;
a plasma lamp mounted within said chamber and having a confronting relationship with said interior surface, said plasma lamp containing a gas mixture capable of emitting infrared and ultraviolet radiation when said gas mixture is excited to generate a plasma;
an excitation power source coupled to said plasma lamp for exciting the plasma from said gas mixture such that radiation having infrared and ultraviolet wavelengths is emitted by said plasma lamp;
a reflector positioned in said chamber between said plasma lamp and said wall, said reflector having a front surface facing said plasma lamp and a rear surface, said reflector capable of reflecting ultraviolet radiation emitted by said plasma lamp toward the substrate and transmitting infrared radiation emitted by said plasma lamp so that the transmitted infrared radiation irradiates said interior surface of said wall, and said reflector capable of absorbing a significant portion of the transmitted infrared radiation subsequently reflected from said interior surface of said wall with optical paths directed toward said rear surface of said reflector; and
an infrared-absorptive coating covering at least a portion of said interior surface of said wall, said infrared-absorptive material capable of absorbing a significant portion of the infrared radiation incident thereon for significantly reducing the amount of infrared radiation reflected from said interior surface.

14. The ultraviolet radiation generating system of claim 13, wherein said rear surface further comprising a surface treatment capable of absorbing said portion of said infrared radiation.

15. The ultraviolet radiation generating system of claim 14, wherein said rear surface is roughened to absorb said infrared radiation.

16. The ultraviolet radiation generating system of claim 13, wherein said front surface is concave and said rear surface is convex, said rear surface further comprising a surface treatment capable of absorbing said portion of said infrared radiation.

17. The ultraviolet radiation generating system of claim 13, wherein said reflector is capable of absorbing substantially all of said infrared radiation reflected by said interior surface of said wall with optical paths directed toward said rear surface of said reflector.

18. The ultraviolet radiation generating system of claim 13, wherein said infrared-absorptive coating absorbs substantially all of the infrared radiation incident thereon.

19. The ultraviolet radiation generating system of claim 13, wherein said infrared-absorptive coating is selected from the group consisting of a colored paint, a colored powder coating, a colored oxide layer, a color-pigmented PTFE layer, a colored anodized layer, a colored chemically-vapor-deposited film, a colored physically-vapor-deposited film, and combinations thereof.

20. The ultraviolet radiation generating system of claim 12, wherein said infrared-absorptive coating is selected from the group consisting of a black paint, a black powder coating, a black oxide layer, a black-pigmented PTFE layer, a black anodized layer, a black chemically-vapor-deposited film, a black physically-vapor-deposited film, and combinations thereof.

21. The ultraviolet radiation generating system of claim 12, wherein said infrared-absorptive coating comprises a plurality of coloring pigment particles that is capable of absorbing infrared radiation.

22. The ultraviolet radiation generating system of claim 19, wherein said infrared-absorptive coating further comprises a polymeric vehicle, said polyermic vehicle adhering said coloring pigment to said is adhered to said interior surface of said wall.
